(19) United States
(12) Patent Application Publication
(10) Pub. No.: US 2021/0287550 A1
(43) Pub. Date: Sep. 16, 2021

(54) VEHICLE DISPATCH SERVICE DEVICE FOR DISPATCH TO SHELTER, VEHICLE DISPATCH SERVICE METHOD FOR DISPATCH TO SHELTER, AND NON-TRANSITORY COMPUTER-READABLE MEDIUM STORING PROGRAM

(71) Applicant: HONDA MOTOR CO., LTD., Tokyo (JP)

(72) Inventor: Takamasa MORI, Tokyo (JP)

(21) Appl. No.: 17/195,550

(22) Filed: Mar. 8, 2021

(30) Foreign Application Priority Data
Mar. 13, 2020 (JP) 2020-044147

(51) Int. Cl. G08G 1/00; B60L 55/00; G07C 5/08; G07C 5/00; G06Q 50/30; H04W 4/40

(52) U.S. Cl. CPC G08G 1/202; B60L 55/00; H04W 4/40; G07C 5/008; G06Q 50/30; G07C 5/0808

(57) ABSTRACT

A vehicle dispatch service device 100 for dispatch to a shelter includes: a calculation unit 130 that calculates an optimum vehicle dispatch pattern for dispatching an electric vehicle 200 on the basis of a vehicle request received by a communication unit 110 from a terminal device 300 of user, vehicle notification information 164 stored in a storage unit 160, received by the communication unit 110, and including identification information about the electric vehicle 200, positional information about the electric vehicle 200, and information indicating a charging state of the electric vehicle 200, and master information about each shelter stored in advance in the storage unit 160; and a management unit 140 that outputs information instructing dispatch of the electric vehicle 200 according to the vehicle dispatch pattern calculated by the calculation unit.

This application is based on and claims the benefit of priority from Japanese Patent Application 2020-044147, filed on 13 Mar. 2020, the content of which is incorporated herein by reference.

### BACKGROUND OF THE INVENTION

### Field of the Invention

The present invention relates to a vehicle dispatch service device for dispatch to a shelter, a vehicle dispatch service method for dispatch to a shelter, and a non-transitory computer-readable medium storing a program.

### Related Art

There have recently been known electric vehicles caused to travel by electric motors driven by electric power supplied from secondary cells (batteries). Such electric vehicles include battery electric vehicles (BEVs), hybrid electric vehicles (HEVs), plug-in hybrid electric vehicles (PHEVs), fuel cell vehicles (FCVs), and plug-in fuel ceil vehicles (PFCVs).

A technique wherein a plurality of users use the same common vehicle is known in relation to a service using vehicles (see patent document 1, for example).

Patent Document 1: Japanese Unexamined Patent Application, Publication No. 2003-6294

### SUMMARY OF THE INVENTION

Due to wind or flood damage caused by typhoons, tornados, floods, etc., long-term large-scale power outages occur. This imposes difficulty in maintaining daily life. This further causes hindrance not only to activity of evacuation to shelters but also to reconstruction after being stricken by wind or flood damage.

An object of the present invention is to provide a vehicle dispatch service device for dispatch to a shelter, a vehicle dispatch service method for dispatch to a shelter, and a non-transitory computer-readable medium storing a program allowing dispatch of a vehicle capable of supplying electricity to a shelter on the occurrence of long-term large-scale power outages.

To attain the foregoing object, an aspect of the present invention provides a vehicle dispatch service device for dispatch to a shelter (vehicle dispatch service device 100 described later, for example) including: a communication unit (communication unit 110 described later, for example) that makes communication with a vehicle-installed communication device (vehicle-installed communication device 282 described later, for example) and with a terminal device (terminal device 300 described later, for example) of a user (user U described later, for example); a calculation unit (calculation unit 130 described later, for example) that calculates an optimum vehicle dispatch pattern for dispatching an electric vehicle (electric vehicle 200 described later, for example) on the basis of a vehicle request received by the communication unit from the terminal device of the user, vehicle notification information stored in a storage unit, received by the communication unit, and including identification information about the electric vehicle, positional information about the electric vehicle, and information indicating a charging state of the electric vehicle, and master information about each shelter stored in advance in the storage unit; and a management unit (management unit 140 described later, for example) that outputs information instructing dispatch of the electric vehicle according to the vehicle dispatch pattern calculated by the calculation unit.

Another aspect of the present invention provides a vehicle dispatch service method for dispatch to a shelter, the method being implemented by a vehicle dispatch service device for dispatch to the shelter including a communication unit that makes communication with a vehicle-installed communication device and with a terminal device of a user. The method includes: calculating an optimum vehicle dispatch pattern for dispatching an electric vehicle on the basis of a vehicle request received by the communication unit from the terminal device of the user, vehicle notification information stored in a storage unit, received by the communication unit, and including identification information about the electric vehicle, positional information about the electric vehicle, and information indicating a charging state of the electric vehicle, and master information about each shelter stored in advance in the storage unit; and outputting information instructing dispatch of the electric vehicle according to the vehicle dispatch pattern.

Yet another aspect of the present invention provides a non-transitory computer-readable medium storing a program for causing a vehicle dispatch service device for dispatch to a shelter to perform a process. The vehicle dispatch service device includes a communication unit that makes communication with a vehicle-installed communication device and with a terminal device of a user. The process includes: calculating an optimum vehicle dispatch pattern for dispatching an electric vehicle on the basis of a vehicle request received by the communication unit from the terminal device of the user, vehicle notification information stored in a storage unit, received by the communication unit, and including identification information about the electric vehicle, positional information about the electric vehicle, and information Indicating a charging state of the electric vehicle, and master information about each shelter stored in advance in the storage unit; and outputting information instructing dispatch of the electric vehicle according to the vehicle dispatch pattern.

Thus, it becomes possible to encourage a match in a database of the storage unit of the vehicle dispatch service device between a shelter and an electric vehicle. This allows selection of an appropriate number of electric vehicles and dispatch of these electric vehicles to respective shelters having different capacities for persons to be accommodated and thus differing in required electricity or fuel from each other, thereby allowing uniform and optimum vehicle dispatch to each shelter.

In this case, the electric vehicle preferably includes a situation acquisition device (external monitoring unit 280 described later, for example) configured to acquire situation information about a traveling area where the electric vehicle is traveling, the vehicle notification information preferably includes the situation information, and the vehicle notification information stored in the storage unit preferably includes the situation information.

By doing so, in there is submergence due to flooding, stone fall, fall of ground, or bridge collapse on a route to a shelter along which the electric vehicle toward the shelter is to travel, or if positional information about an electric vehicle having started previously toward the shelter stops changing at a position before arrival at the shelter (if this previous electric vehicle is hit by an accident and becomes disabled to move), for example, the possibility or impossibility of dispatch of the electric vehicle intended to be directed to the shelter can be determined using the situation of a road toward the shelter. For example, it is determined that dispatch of this electric vehicle to the shelter should be avoided.

In this case, the electric vehicle is preferably a vehicle capable of driving by self-driving, and the management unit preferably instructs the electric vehicle to move to the shelter by self-driving. By doing so, even if the electric vehicle is hit by an accident such as stone fall or fall of ground on the way to the shelter, for example, it still becomes possible to avoid loss of human life.

In this case, the master information preferably includes a minimum quantity of electricity usage at each shelter. This allows calculation of the number of required electric vehicles that may be the number of electric vehicles and a degree of charging of each of these electric vehicles, for example.

In this case, the master information preferably includes information about the presence or absence of a power generating facility at the shelter, and includes a minimum quantity of fuel required for generating a minimum quantity of electricity usage at the shelter. By doing so, when the electric vehicle is to be dispatched to the shelter with the power generating facility, the electric vehicle to be dispatched is allowed to travel toward the shelter, while being loaded with fuel of a required quantity. Additionally, a person handling the fuel can be carried to the shelter. If the shelter has a certain quantity of fuel to be used for power generation by the power generating facility, the vehicle dispatch pattern may be calculated on the assumption that electricity to be supplied from the electric vehicle corresponds to shortage relative to the quantity of electricity to be generated by the power generating facility.

In this case, the electric vehicle is preferably a hybrid vehicle with an internal combustion engine and a motor to generate power using the drive power of the internal combustion engine, or a fuel ceil vehicle. Thus, if there is a need of using heat such as a need of boiling water at the shelter, heat generated by the power generation by the hybrid vehicle can be used for the boiling.

In this case, the calculation unit preferably calculates a vehicle dispatch pattern for causing a fuel supply vehicle capable of supplying fuel to the electric vehicle to arrive at the shelter to coincide with timing of running out of fuel in the electric vehicle required for power generation. This makes it possible to avoid a trouble such as failing to supply electricity to the shelter due to running out of fuel in the electric vehicle.

In this case, the electric vehicle is preferably a battery electric vehicle, and the calculation unit is preferably configured to calculate a traveling permitting residual charged quantity indicating a residual charged quantity in the electric vehicle allowing the electric vehicle to travel from the shelter to a charging station ready for charging. By doing so, if there are no sufficient number of electric vehicles capable of being dispatched to the shelter, if supply of electricity to the shelter using electric vehicles is to be prolonged, and if a vehicle dispatched to the shelter for supply of electricity to the shelter is a battery electric vehicle (BEV), the dispatched vehicle can be charged at the charging station ready for charging, and then can be used again for supply of electricity at the shelter.

In this case, the electric vehicle is preferably a fuel cell vehicle, and the calculation unit is preferably configured to calculate a traveling permitting residual charged quantity indicating a residual charged quantity in the electric vehicle allowing the electric vehicle to travel from the shelter to a hydrogen station ready for charging. In the case of a fuel cell vehicle, the traveling permitting residual charged quantity may be calculated by giving consideration not only to a residual charged quantity in a battery further available for traveling but also to a hydrogen quantity remaining in a hydrogen tank. By doing so, if there are no sufficient number of electric vehicles capable of being dispatched to the shelter, if supply of electricity to the shelter using electric vehicles is to be prolonged, and if a vehicle dispatched to the shelter for supply of electricity to the shelter is a fuel ceil vehicle, the dispatched vehicle can be charged with hydrogen at the hydrogen station, and then can be used again for supply of electricity at the shelter.

In this case, the electric vehicle is preferably a hybrid vehicle (HEV or PHEV), the calculation unit is preferably configured to calculate a traveling permitting residual charged quantity indicating a residual charged quantity in the electric vehicle allowing the electric vehicle to travel from the shelter to a gas station ready for charging. The traveling permitting residual charged quantity may be calculated by giving consideration not only to a residual charged quantity in a battery further available for traveling but also to residual fuel remaining in a fuel tank. By doing so, if there are no sufficient number of electric vehicles capable of being dispatched to the shelter, if supply of electricity to the shelter using electric vehicles is to be prolonged, end if a vehicle dispatched to the shelter for supply of electricity to the shelter is a hybrid vehicle, the dispatched vehicle can be charged with fuel at the gas station, and then can be used again for supply of electricity at the shelter.

In this case, the vehicle dispatch pattern is preferably calculated for causing one electric vehicle to arrive at the shelter to coincide with timing of reach of the traveling permitting residual charged quantity by a residual charged quantity in a different electric vehicle. This makes it possible to avoid the occurrence of shortage of electric vehicles to supply electricity at the predetermined shelter.

The present invention allows provision of a vehicle dispatch service device for dispatch to a shelter, a vehicle dispatch service method for dispatch to a shelter, and a non-transitory computer-readable medium storing a program allowing dispatch of a vehicle capable of supplying electricity to a shelter on the occurrence of long-term large-scale power outages.

### BRIEF DESCRIPTION OF THE DRAWINGS

FIG. 1 is a view of a vehicle system including a vehicle dispatch service device for dispatch to a shelter according to an embodiment of the present invention;

FIG. 2 shows the configuration of an electric vehicle to be dispatched by the vehicle dispatch service device for dispatch to a shelter according to the embodiment of the present invention;

FIG. 3 shows an example of vehicle information about an electric vehicle to be dispatched by the vehicle dispatch service device for dispatch to a shelter according to the embodiment, of the present invention;

FIG. 4 shows an example of user information about a user of the vehicle dispatch service device for dispatch to a shelter according to the embodiment of the present invention;

FIG. 5 shows an example of vehicle notification information in the vehicle dispatch service device for dispatch to a shelter according to the embodiment of the present invention; and

FIG. 6 is a flowchart showing control relating to the vehicle dispatch service device for dispatch to a shelter according to the embodiment of the present invention.

### DETAILED DESCRIPTION OF THE INVENTION

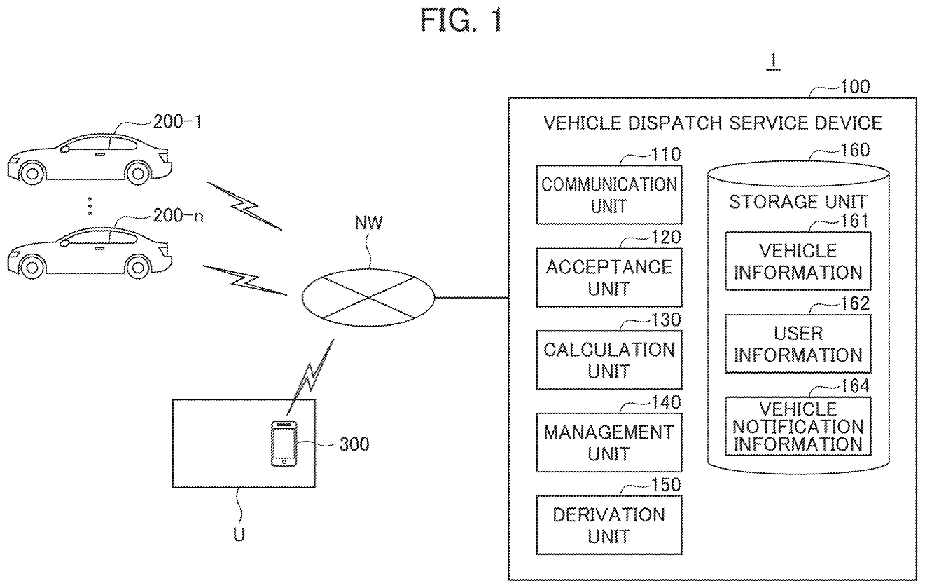

An embodiment of the present invention will be described in detail below by referring to the drawings. FIG. 1 is a view of a vehicle system 1 including a vehicle dispatch service device 100 for dispatch to a shelter.

The vehicle system 1 of the embodiment includes the vehicle dispatch service device 100, electric vehicles 200-1 to 200-n (n is an integer of greater than 1), and one or more terminal devices 300 used by one or more users U. “Being used by the user U” may include a case where the user U temporarily uses a terminal device that can be used by an unspecified large number of people such as a terminal device at an Internet cafe.

The vehicle dispatch service device 100, each of the electric vehicles 200-1 to 200-n, and the one or more terminal devices 300 are communicable with each other through a network NW. The network NW includes the Internet, a wide area network (WAN), a local area network (LAN), a public line, a provider device, a dedicated line, a wireless base station, etc. In the embodiment, each of the electric vehicles 200-1 to 200-n stop at parking lots used by respective owners of the electric vehicles 200-1 to 200-n.

The user U is a country or a local public organization, for example, authorized to supply electricity or transport goods to a shelter on the occurrence of wind or flood damage. In response to an instruction from the user U, electricity of a predetermined quantity or goods are supplied to each shelter on the occurrence of wind or flood damage. As a specific example, to supply electricity or fuel at a predetermined shelter, the user U makes a request for dispatch of a predetermined number of PHEVs charged to predetermined values or more to the predetermined shelter. When the user U makes the vehicle dispatch request, the vehicle dispatch service device 100 calculates an optimum vehicle dispatch pattern for dispatching an electric vehicle on the basis of the position of each of the electric vehicles 200-1 to 200-n, information about the charging state of each of the electric vehicles 200-1 to 200-n, and master information about the shelter-designated by the U. Then, the vehicle dispatch service device 100 outputs information instructing dispatch of the electric vehicle according to the calculated vehicle dispatch pattern and dispatches the vehicle, thereby providing the vehicle dispatch service.

Each of the electric vehicles 200-1 to 200-n generates vehicle notification information including vehicle identification information, vehicle positional information, and information indicating the charging state of a vehicle, and transmits the generated vehicle notification information to the vehicle dispatch service device 100. The vehicle dispatch service device 100 receives the vehicle notification information transmitted from each of the electric vehicles 200-1 to 200-n. The vehicle dispatch service device 100 acquires the vehicle identification information, the vehicle positional information, and the information indicating the charging state of a vehicle included in each of one or more of the acquired pieces of vehicle notification information. The vehicle dispatch service device 100 stores the acquired one or more pieces of vehicle identification information, vehicle positional information, information indicating the charging state of a vehicle, and master information stored in advance about a predetermined shelter in association with each other.

Each of the electric vehicles 200-1 to 200-n is configured using a self-driving vehicle. Using a self-driving vehicle as an electric vehicle to be dispatched makes it possible to prevent a driver driving the electric vehicle from being a victim on the way to a shelter due to involvement of the electric; vehicle toward the shelter in an accident or secondary disaster.

When the user U requests dispatch of an electric vehicle to the predetermined shelter, the user U performs operation of requesting an electric vehicle using the terminal device 300. When the user U performs the operation of requesting dispatch of an electric vehicle, a vehicle request directed to the predetermined shelter is generated. The terminal device 300 transmits the generated vehicle request to the vehicle dispatch service device 100.

The vehicle dispatch service device 100 receives the vehicle request transmitted from the terminal device 300, and acquires information about the predetermined shelter included in the received vehicle request. The vehicle dispatch service device 100 specifies information about electricity quantity required at the predetermined shelter, fuel quantity required for power generation at a power generating facility prepared at the shelter, information about the necessity of heat supply to the shelter, etc. using the master information stored in advance about the predetermined shelter. Then, the vehicle dispatch service device 100 calculates a combination of electric vehicles that can be dispatched to the predetermined shelter on the basis of the specified information, thereby calculating a vehicle dispatch pattern.

Next, the vehicle dispatch service device 100 selects an electric vehicle that can be dispatched to the predetermined shelter from the electric vehicles, and generates a vehicle dispatch instruction directed to the vehicle to be dispatched and including positional information about the predetermine shelter and information instructing vehicle dispatch to the position of the predetermined shelter. The vehicle dispatch service device 100 transmits the generated vehicle dispatch instruction to the electric vehicle to be dispatched.

The vehicle dispatch service device 100 derives provision time indicating the time when the electric vehicle to be dispatched can be provided to the position of the predetermined shelter on the basis of the position of the electric vehicle to be dispatched and the position of the predetermined shelter. The vehicle dispatch service device 100 generates a vehicle response directed to the terminal device 300 including information indicating that the vehicle dispatch has been instructed and information indicating the provision time, and transmits the generated vehicle response to the terminal device 300.

The following describes the details of the electric vehicles 200-1 to 200-n, the vehicle dispatch service device 100, and the terminal device 300 included in the vehicle system 1. In the following description, an optional electric vehicle belonging to the electric vehicles 200-1 to 200-n will be called an electric vehicle 200.

[Electric vehicle 200]

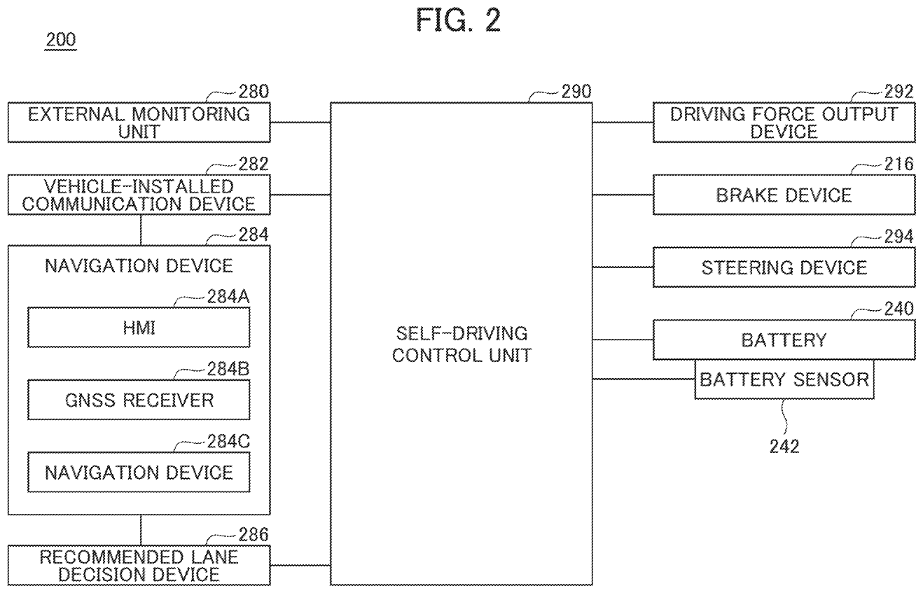

FIG. 2 shows the configuration of the electric vehicle 200 to be dispatched by the vehicle dispatch service device 100 for dispatch to a shelter. The electric vehicle 200 includes an external monitoring unit 280, a vehicle-installed communication device 282, a navigation device 284, a recommended lane decision device 286, a self-driving control unit 290, a driving force output device 292, a brake device 216, a steering device 294, a battery 240, and a battery sensor 242, for example.

The external monitoring unit 280 forms a situation acquisition device, and includes a camera, a radar, a light detection and ranging (LIDAR) unit, and an object recognition device that performs sensor fusion process on the basis of outputs from these units, for example. The external monitoring unit 230 estimates the type of an object existing around the electric vehicle 200 (in particular, an electric vehicle, a pedestrian, a bicycle, or a road situation such as submergence or bridge collapse, for example) to generate estimated information (situation information), and outputs the estimated information together with information about the position or speed of the object to the self-driving control unit 290.

The vehicle-installed communication device 282 is a wireless communication module for making a connection to the network NW or making direct communication with a different electric vehicle or a terminal device of a pedestrian, for example. The vehicle-installed communication device 282 makes wireless communication based on Wi-Fi, dedicated short range communications (DSRC), Bluetooth (registered trademark), or other types of communication standards. Two or more types of devices may be prepared as the vehicle-installed communication device 282. The vehicle-installed communication device 282 acquires a current value, a voltage value, and information indicating a temperature output from the self-driving control unit 290. The vehicle-installed communication device 282 acquires a calculation result about an SOC output from the self-driving control unit 290. The vehicle-installed communication device 282 acquires positional information about the electric vehicle 200 output from a GNSS receiver 284B. The vehicle-installed communication device 282 generates vehicle notification information directed to the vehicle dispatch service device 100 including the acquired current value/ voltage value, and information indicating a temperature, the acquired information indicating the charging state of the electric vehicle 200 such as the SOC, the acquired positional Information about the electric vehicle 200, and the estimated information generated by the external monitoring unit 280. The vehicle-installed communication device 282 transmits the generated vehicle notification information to the vehicle dispatch service device 100 through the network NW shown in FIG. 1.

The navigation device 284 includes a human machine interface (HMI) 284A, the GNSS receiver 284B, and a navigation controller 284C, for example. The HMI 284A includes a touch-panel display device, a speaker, a microphone, etc., for example. The GNSS receiver 284B measures the position of a machine (the position of the electric vehicle 200) on the basis of a radio wave coming from a GNSS satellite (a GPS satellite, for example). The navigation controller 284C includes a CPU and various types of storage devices, for example, and controls the navigation device 284 entirely. The storage device stores map information (navigation map). The navigation map is a map including roads expressed by nodes and links. On the basis of the position of the electric vehicle 200 measured by the GNSS receiver 284B, the navigation controller 284C decides a route to a destination by referring to the navigation map. The destination mentioned herein may be designated using the HMI 284A or may be designated using positional, information about the electric vehicle 200 included in a vehicle dispatch instruction. The navigation controller 284C may transmit the position of the electric vehicle 200 and the predetermined shelter as a destination to a navigation server (not shown) using the vehicle-installed communication device 282, and acquire a route transmitted as a reply from the navigation server. The route may include information about a stopping point for getting on or getting off by an owner of the electric vehicle 200, and an intended arrival time. As will be described later, in the presence of a power generating facility at the shelter, the route may include a point of loading of fuel for power generation on the electric vehicle 200 to be transported to the power generating facility at the shelter by the electric vehicle 200. The navigation controller 284C outputs information about the route decided by any of the foregoing methods to the recommended lane decision device 286.

The recommended lane decision device 286 includes a map positioning unit (MPU) and various types of storage devices, for example. The storage device includes highly accurate map information covering further details than the navigation map. The highly accurate map information includes information such as a road width, a grade, a curvature, and positions of signals about each lane, for example. The recommended lane decision device 286 decides a recommended lane preferable for traveling along a route input from the navigation device 284, and outputs the decided recommended lane to the self-driving control unit 290.

The self-driving control unit 290 includes one or more processors such as a CPU or an MPU, and various types of storage devices. On the principle of traveling along the recommended lane decided by the recommended lane decision device 286, the self-driving control unit 290 causes the electric vehicle 200 to travel automatically in such a manner as to avoid contact with an object at a position or speed input from the external monitoring unit 280. The self-driving control unit 290 performs various types of events sequentially, for example. The events include a constant-speed traveling event of traveling along one traveling lane at a constant speed, a tracking traveling event of traveling while tracking a vehicle traveling ahead, a lane changing event, a merging event, a branching event, an emergency stopping event, a tollgate event for passing through a tollgate, and a handover event for finishing self-driving and making a switch to manual driving, for example. During implementations of these events, action for the avoidance may be planned on the basis of a situation around the electric vehicle 200 (the presence of a neighboring vehicle or pedestrian, lane narrowing resulting from a roadwork, for example).

The self-driving control unit 290 generates an intended orbit in which the electric vehicle 200 is to travel in the future. The intended orbit includes a speed element, for example. For example, the intended orbit is expressed by a line of sequentially arranged points (orbital points) to be reached by the electric vehicle 200. The orbital points are points to be reached by the electric vehicle 200 and are defined at a predetermined traveling distance. Separately from the orbital points, an intended speed and an intended acceleration defined for each predetermined sampling period (a few tenths of a second, for example) are generated as part of the intended orbit. The orbital points may be positions to be reached by the electric vehicle 200 at the time of sampling in each predetermined period of the sampling. In this case, information such as an intended speed and an intended acceleration is expressed using an interval between the orbital points. The self-driving control unit 290 calculates the SOC of the battery 240 on the basis of output from the battery sensor 242 attached to the battery 240, and outputs a calculation result about the SOC to the vehicle-installed communication device 282. The self-driving control unit 290 outputs a current value, a voltage value, and information indicating a temperature output from the battery sensor 242 to the vehicle-installed communication device 282.

The battery 240 is a secondary cell such as a lithium-ion cell, for example. The battery 240 stores electric power introduced from a charger outside the electric vehicle 200, and discharges energy for causing the electric vehicle 200 to travel.

The battery sensor 242 includes a sensor such as a current sensor, a voltage sensor, or a temperature sensor, for example. The battery sensor 242 detects the current value, voltage value, and temperature of the battery 240, for example. The battery sensor 242 outputs the detected current value and voltage value, and information about the detected temperature to the self-driving control unit 290. The battery sensor 242 may include a plurality of sensors, such as a current sensor, a voltage sensor, or a temperature sensor, respectively. In the presence of a plurality of such sensors as the battery sensor 242, a battery sensor identifier may be given to each of a current value, a voltage value, and information indicating a temperature to be output to the self-driving control unit 290. The battery sensor identifier is an identifier allowing a plurality of the sensors provided in the electric vehicle 200 to be discriminated from each other. The battery sensor identifier may be expressed by alphanumeric characters determined in advance, for example.

An example of a self-driving operation process by the electric vehicle 200 will be described. First, the navigation device 284 decides a route. This route is a rough route without distinction of lanes, for example. Next, the recommended lane decision device 286 decides a recommended lane that facilitates traveling along the route. Then, the self-driving control unit 290 generates orbital points for traveling along the recommended lane as correctly as possible while avoiding an obstacle, for example, and controls some or all of the driving force output device 292, the brake device 216, and the steering device 294 in order to achieve traveling along the orbital points (and along an accompanying speed profile). Such role sharing is merely shown as an example. The self-driving control unit 290 may perform the process in a centralized manner, for example.

The driving force output device 292 outputs traveling driving force (torque) to drive wheels for causing the electric vehicle to travel. The driving force output device 292 includes a combination of an internal combustion engine, a motor, and a transmission, etc., and a power ECU for controlling these units, for example. The power ECU controls the configuration described above in response to information input from the self-driving control unit 290 or information input from a driving operator not shown.

The brake device 216 includes a brake caliper, a cylinder that transmits hydraulic pressure to the brake caliper, an electric motor that generates the hydraulic pressure at the cylinder, and a brake ECU, for example. The brake ECU controls the electric motor in response to information input from the self-driving control unit 290 or information input from a driving operator, and causes a brake torque responsive to a braking operation to be output to each wheel. The brake device 216 may include a mechanism as a backup to transmit hydraulic pressure generated by operation on a brake pedal included in the driving operator to the cylinder through a master cylinder. The brake device 216 is not limited to the configuration described above but may be an electronically-controlled hydraulic brake device that controls an actuator in response to information input from the self-driving control unit 290 and transmits hydraulic pressure at the master cylinder to the cylinder.

The steering device 294 includes a steering ECU and an electric motor, for example. The electric motor causes force to act on a rack-and-pinion mechanism to change the direction of a turning wheel, for example. The steering ECU drives the electric motor in response to information input from the self-driving control unit 290 or information input from a driving operator, and changes the direction of the turning wheel.

### [Vehicle Dispatch Service Device 100]

The vehicle dispatch service device 100 is realized using a device such as a personal computer, a server, or an industrial computer, for example. The vehicle dispatch service device 100 includes a communication unit 110, an acceptance unit 120, a determination unit 130, a management unit 140, a derivation unit 150, and a storage unit 160, for example.

The communication unit 110 is realized using a communication module. More specifically, the communication unit 110 is configured using a device to make wire communication. The communication unit 110 may be configured using a wireless device to make wireless communication by a wireless communication technique such as LTE or a wireless LAN, for example. The communication unit 310 communicates through the network NW with the terminal device 300 and with the vehicle-installed communication device 282 in the electric vehicle 200 as a self-driving vehicle. More specifically, the communication unit 110 receives vehicle notification information transmitted from the vehicle-installed communication device 282 in the electric vehicle 200 as a self-driving vehicle, and outputs the received vehicle notification information to the acceptance unit 120. The communication unit 110 receives a vehicle request transmitted from the terminal device 300, and outputs the received vehicle request to the acceptance unit 120. The communication unit 110 acquires a vehicle dispatch instruction output from the management unit 140, and transmits the acquired vehicle dispatch instruction to the electric vehicle 200 to be dispatched. The communication unit 110 acquires a vehicle response output from the management unit 340, and transmits the acquired vehicle response to the terminal device 300.

The storage unit 160 is realized using a hard disk drive (HDD), a flash memory, a random access memory (RAM), or a read only memory (ROM), for example. The storage unit 160 stores vehicle information 161, user, information 162, and vehicle notification information 164. The vehicle information 161, the user information 162, and the vehicle notification information 164 may be stored on the cloud.

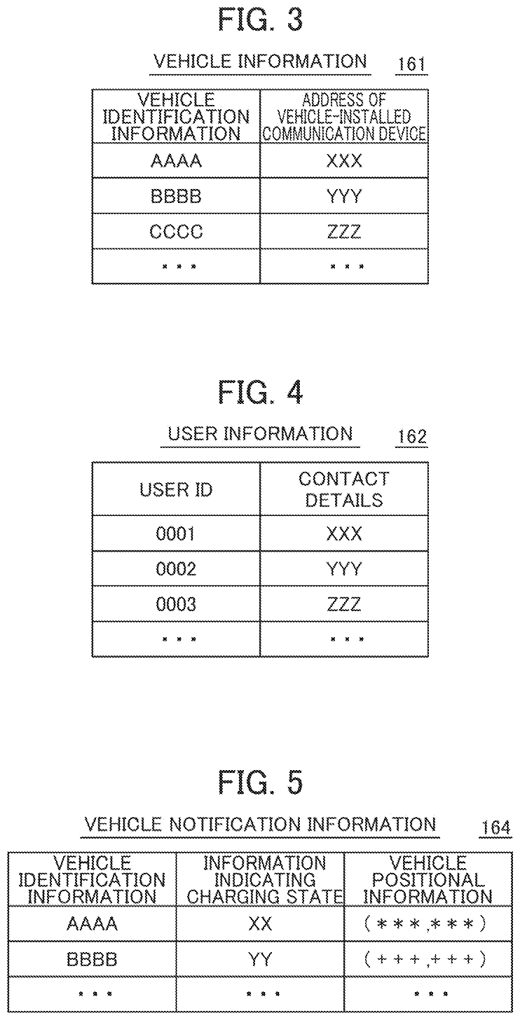

FIG. 3 shows an example of vehicle information. The vehicle information 161 is information in a table format including vehicle identification information about the electric vehicle 200 and an address of a vehicle-installed communication device installed on the electric vehicle 200 stored in association with each other. An example of an address of the vehicle-installed communication device is an IP address. In the example shown in FIG. 3, the vehicle information 161 includes vehicle identification information “AAAA” about the electric vehicle 200 and an address “XXX” of a vehicle-installed communication device stored in association with each other, vehicle identification information “BBBB” about the electric vehicle 200 and an address “YYY” of a vehicle-installed communication device stored in association with each other, and vehicle identification information “CCCC” about the electric vehicle 200 and an address “ZZZ” of a vehicle-installed communication device stored in association with each other. These pieces of information are registered at the time of introduction of the electric vehicle 200 into the vehicle system 1.

FIG. 4 shows an example of user information. The user information 162 is information in a table format including a user ID and a contact details with the user U corresponding to the user ID stored in association with each other. An example of contact details with the user U is an e-mail address. In the example shown in FIG. 4, the user information 162 includes a user ID “0001” and contact details “XXX” stored in association with each other, a user ID “0002” and contact details “YYY” stored in association with each other, and a user ID “0003” and contact details “ZZZ” stored in association with each other. These pieces of information are registered when the user U starts using the vehicle system 1.

FIG. 5 shows an example of vehicle notification information. The vehicle notification information 164 is information in a table format including vehicle identification Information about the electric vehicle 200, information indicating the charging state of the electric vehicle 200, and vehicle positional information about the electric vehicle 200 stored in association with each other. An example of vehicle positional information about the electric vehicle 200 is expressed as (longitude, latitude). In the example shown in FIG. 5, the vehicle notification information 164 includes vehicle identification information “AAAA” about the electric vehicle 200, information “XX” Indicating the charging state of the electric vehicle 200, and vehicle positional information “(***, ***)” about the electric vehicle 200 stored in association with each other, and vehicle identification information “BBBB” about the electric vehicle 200, information “YY” indicating the charging state of the electric vehicle 200, and vehicle positional information “(+++, +++)” about the electric vehicle 200 stored in association with each other. The information “XX” indicating the charging state of the electric vehicle 200 is the state of charge of a secondary cell (battery 240) in the electric vehicle 200, for example. These pieces of information are updated on the basis of vehicle notification information transmitted from the electric vehicle 200.

The acceptance unit 120, the calculation unit 130, the management unit 140, and the derivation unit 150 are realized by causing a hardware processor such as a central processing unit (CPU) to execute a program (software) stored in the storage unit 160, for example. Some or all of these functional units may be realized using hardware (circuit section including circuitry) such as a large scale integration (LSI), an application specific integrated circuit (ASIC), a field-programmable gate array (FPGA), or a graphics processing unit (GPU), for example, or may be realized by causing software and hardware working cooperatively. The program may be stored in advance in a storage device (a storage device with a non-transitory storage medium) such as a hard disk drive (HDD) or a flash memory. Alternatively, the program may be stored in an attachable/detachable storage medium (a non-transitory storage medium) such as a DVD or a CD-ROM, and may be installed by attaching the storage medium to a drive.

Processes described separately in the following to be performed by the acceptance unit 120, the calculation unit 130, the management unit 140, and the derivation unit 150 include a process to be performed before the user U requests dispatch of an electric vehicle, and a process to be performed after the user U requests dispatch of the electric vehicle by operating the terminal device 300.

Described first is the process to be performed before the user U requests dispatch of a vehicle to the predetermined shelter. The vehicle-installed communication device 282 of the electric vehicle 200 acquires vehicle identification information, information indicating a charging state, and positional information about the electric vehicle 200, and generates vehicle notification information directed to the vehicle dispatch service device 100 and including the acquired vehicle identification information, information indicating a charging state, and positional information about the electric vehicle 200. The vehicle-installed communication device 282 transmits the generated vehicle notification information to the vehicle dispatch service device 100. The communication unit 110 of the vehicle dispatch service device 100 receives the vehicle notification information transmitted from the vehicle-installed communication device 282, and outputs the received vehicle notification information to the acceptance unit 120.

The acceptance unit 120 acquires the vehicle notification Information output from the communication unit 110, and acquires the vehicle identification information, the information indicating a charging state, and the positional information about the electric vehicle 200 included in the acquired vehicle notification information. The acceptance unit 120 stores the acquired vehicle identification information, Information indicating a charging state, and positional information about the electric vehicle 200 in association with each other into the vehicle notification information 164 in the storage unit 160.

The storage unit 160 stores master information about the predetermined shelter as a destination of dispatch of an electric vehicle to be requested by the user U. The master information includes positional information about the shelter, a capacity for persons to be accommodated in the shelter, information about a minimum quantity of electricity usage required at the shelter, the presence or absence of a power generating facility at the shelter, information about a minimum quantity of fuel required for fulfilling the minimum quantity of electricity usage required at the shelter to generate power using the power generating facility, information about the necessity of heat supply to the shelter, etc.

Described next is the process to be performed after the user U requests vehicle dispatch to the predetermined shelter by operating the terminal device 300. The terminal device 300 generates a vehicle request (request for vehicle dispatch) directed to the vehicle dispatch service device 100 including information indicating that vehicle dispatch to the predetermined shelter is requested. The terminal device 300 transmits the generated vehicle request to the vehicle dispatch service device 100.

The acceptance unit 120 acquires the vehicle request output from the communication unit 110, and outputs the acquired vehicle request to the calculation unit 130. The calculation unit 130 acquires the vehicle request output from the acceptance unit 120, and acquires vehicle identification information included in the acquired vehicle request. On the basis of vehicle positional information associated with the acquired vehicle identification information and information indicating a charging state associated with vehicle identification information other than the former vehicle identification information, the calculation unit 130 determines whether there is a charged electric vehicle available to the user U using the vehicle notification information 164 in the storage unit 160.

More specifically, on the basis of vehicle positional information acquired from the vehicle notification information 164, the calculation unit 130 determines whether the predetermined shelter is located in an area to which a vehicle can be dispatched. On the basis of the vehicle positional information acquired from the vehicle notification information 164 and positional information about the shelter stored in the storage unit 160, the calculation unit 130 derives a distance between the electric vehicle 200 and the predetermined shelter. If the derived distance between the electric vehicle 200 and the predetermined shelter is equal to or less than a distance threshold, the calculation unit 130 determines that vehicle dispatch service is available to the user U. If the derived distance between the electric vehicle 200 and the predetermined shelter is greater than the distance threshold, the calculation unit 130 determines that vehicle dispatch is not available to the user U. The distance threshold mentioned herein is determined in response to a range allowing dispatch from the position of the electric vehicle 200 to the shelter.

The management unit 140 generates a vehicle dispatch instruction including the vehicle positional information and information instructing vehicle dispatch to the position of the predetermined shelter. The management unit 140 outputs the generated vehicle dispatch instruction to the communication unit 110. The management unit 140 outputs the vehicle dispatch instruction to the derivation unit 150. The derivation unit. 150 acquires positional information about; the predetermined shelter output from the management unit 140, and derives provision time on the basis of the acquired positional information about the predetermined shelter and vehicle positional information about the electric vehicle to be dispatched. The derivation unit 150 outputs information indicating the derived provision time to the management unit 140. The management unit 140 acquires the information indicating the provision time output from the derivation unit 150. The management unit 140 acquires a contact details stored in association with the user U from the user information 162 in the storage unit 160. The management unit 140 generates a vehicle response directed to the contact details (here, the terminal device 300) including information indicating that the vehicle dispatch has been instructed and information indicating the provision time. The management unit 140 outputs the generated vehicle response to the communication unit 110.

If the calculation unit 130 determines on the basis of the distance between the electric vehicle 200 and the predetermined shelter that vehicle dispatch service is not available to the user U, the calculation unit 130 generates a vehicle response directed to the terminal device 300 including information indicating the unavailability of the service. The management unit 140 outputs the generated vehicle response to the communication unit 110.

### [Terminal Device]

The terminal device 300 is a smartphone, a tablet terminal, or a personal computer, for example. In the terminal device 300, an application program or a browser, for example, for using the vehicle system 1 is started to support the service described above. The terminal device 300 is a smartphone, for example, and it is assumed that the application program (app for use of vehicle dispatch service) is running. The app for service use communicates with the vehicle dispatch service device 100 in response to operation by the user U, and gives a push notification based on a vehicle response received from the vehicle dispatch service device 100.

### (Operation of Vehicle System, Vehicle Dispatch Service Method, and Program for Causing Vehicle Dispatch Service Device to Operate to Implement Vehicle Dispatch Service Method)

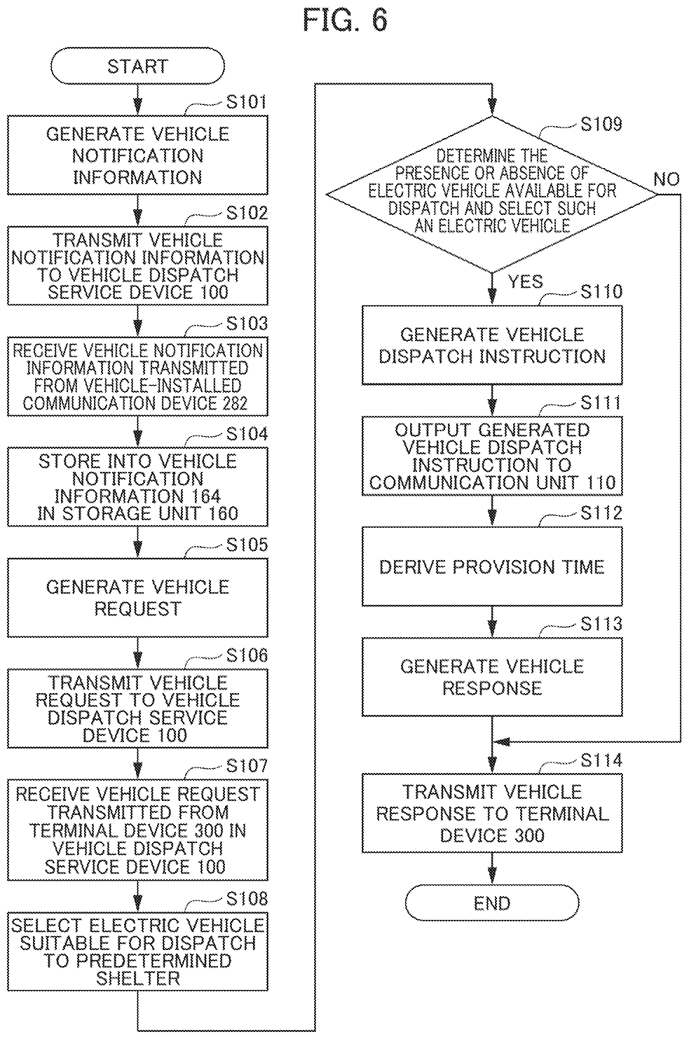

FIG. 6 is a flowchart showing control relating to the vehicle dispatch service device 100 for dispatch to a shelter.

In the electric vehicle 200-n, the vehicle-installed communication device 282 acquires positional information about the electric vehicle 200-n output from the GNSS receiver 284B, an SOC output from the self-driving control unit 290, and a current value, a voltage value, and information indicating a temperature. The vehicle-installed communication device 282 generates vehicle notification information directed to the vehicle dispatch service device 100 including the acquired positional, information, current value, voltage value, information indicating a temperature and information indicating a charging state such as the SOC about the electric vehicle 200-n (step S101).

In the electric vehicle 200-n, the vehicle-installed communication device 282 transmits the generated vehicle notification information to the vehicle dispatch service device 100 (step S102).

In the vehicle dispatch service device 100, the communication unit 110 receives the vehicle notification information transmitted from the vehicle-installed communication device 282 (step S103).

In the vehicle dispatch service device 100, the communication unit 110 outputs the received vehicle notification information to the acceptance unit 120. The acceptance unit 120 acquires the vehicle notification information output from the communication unit 110, and acquires vehicle identification information, vehicle positional information, and information indicating a charging state included in the acquired vehicle notification information. The acceptance unit 120 stores the acquired vehicle identification information, vehicle positional information, and information indicating a charging state in association with each other into the vehicle notification information 164 in the storage unit 160 (step S104).

The user U performs operation on the terminal device 300 to request an electric vehicle. When the user U performs the operation to request an electric vehicle, the terminal device 300 generates a vehicle request directed to the vehicle dispatch .service device 100 including information about the predetermined shelter (step S105).

The terminal device 300 transmits the generated vehicle request to the vehicle dispatch service device 100 (step S106).

In the vehicle dispatch service device 100, the communication unit 110 receives the vehicle request transmitted from the terminal device 300 (step S107).

In the vehicle dispatch service device 100, the communication unit 110 outputs the received vehicle request to the acceptance unit 120. The acceptance unit 120 acquires the vehicle request output from the communication unit 110, and outputs the acquired vehicle request to the calculation unit 130. The calculation unit 130 acquires the vehicle request output from the acceptance unit 120, and acquires vehicle identification information included in the acquired vehicle request. On the basis of vehicle positional information associated with the acquired vehicle identification information, information indicating a charging state associated with vehicle identification information other than the former vehicle identification information, master Information about the predetermined shelter designated by the user U, information about a road situation such as submergence or bridge collapse, for example, and a road width along a route to the predetermined shelter, the calculation unit 130 selects an electric vehicle suitable for dispatch to the predetermined shelter from the vehicle notification information 164 in the storage unit 160 (step S108).

Then, the calculation unit 130 outputs vehicle identification information about each of selected electric vehicles in a set (if only one electric vehicle is selected, the calculation unit 130 outputs vehicle identification information about the one selected electric vehicle) to the management unit 140 (step S109: YES). If the calculation unit 130 determines that there is no electric vehicle satisfying the request from the user U, or if difficulty in arriving at the predetermined shelter is caused due to collapse of a bridge or submergence occurring on the way to the predetermined shelter, for example, the calculation unit 130 generates a vehicle response directed to the terminal device 300 and including information Indicating the unavailability of the service. The management unit 140 outputs the generated vehicle response to the communication unit 110 (step S109: NO). The communication unit 110 acquires the vehicle response output from the calculation unit 130, and transmits the acquired vehicle response to the terminal device 300.

Regarding the type of an electric vehicle to be selected, if electricity is required at the shelter, any electric vehicle to be caused to travel by an electric motor to be driven by electric power supplied from a secondary cell (battery) is selectable. Examples of the selectable electric vehicle include a battery electric vehicle (BEV), a hybrid electric vehicle (HEV), a plug-in hybrid electric vehicle (PHEV), a fuel cell vehicle (FCV), and a plug-in fuel cell vehicle (PFCV). If there is a need of boiling water to be used for taking a shower at the shelter, for example, namely, if supply of electricity and supply of heat are required, an electric vehicle to be selected includes an internal combustion engine or a fuel cell, includes a motor where the drive power of the internal combustion engine or electricity generated by the fuel cell is available, generates heat during power generation, and makes the generated heat available for use. Examples of such an electric vehicle include a hybrid electric vehicle (HEV), a plug-in hybrid electric vehicle (PHEV), a fuel cell vehicle (FCV), and a plug-in fuel cell vehicle (PFCV).

In the vehicle dispatch service device 100, the management unit 140 acquires the one or several pieces of vehicle identification information output from the calculation unit 130. The management unit 140 selects any of the acquired one or several pieces of vehicle identification information to select an electric vehicle to be dispatched. The management unit 140 acquires an address of the vehicle-installed communication device 282 stored in association with the selected vehicle identification information from the vehicle information 161 in the storage unit 160. The management unit 140 generates a vehicle dispatch instruction directed to the acquired address and including vehicle positional information (step S110).

In the vehicle dispatch service device 100, the management unit 140 outputs the generated vehicle dispatch instruction to the communication unit 110 (step S111). The communication unit 110 acquires the vehicle dispatch instruction output from the management unit 140, and transmits the acquired vehicle dispatch instruction to the selected electric vehicle.

In the vehicle dispatch service device 100, the management unit 140 outputs positional information about the predetermined shelter to the derivation unit 150. The derivation unit 150 acquires the positional information about the predetermined shelter output from the management unit 140, and derives provision time on the basis of the acquired positional information about the predetermined shelter and vehicle positional information about the electric vehicle to be dispatched (step S112).

In the vehicle dispatch service device 100, the derivation unit 150 outputs information indicating the derived provision time to the management unit 140. The management unit 140 acquires the information indicating the derived provision time output from the derivation unit 150. The management unit 140 generates a vehicle response directed to the terminal device 300 including information indicating that the vehicle dispatch has been instructed and the information indicating the provision time (step S113).

In the vehicle dispatch service device 100, the management unit 140 outputs the generated vehicle response to the communication unit 110. The communication unit 110 acquires the vehicle response output from the management unit 140, and transmits the acquired vehicle response to the terminal device 300 (step S114). As a result of the foregoing, the selected electric vehicle is dispatched to the predetermined shelter designated by the user U, and the selected electric vehicle arrives at the predetermined shelter at the provision time.

The embodiment achieves the following effect. According to the embodiment, the storage unit 160 stores the vehicle notification information 164 received by the communication unit 110 including identification information about the electric vehicle 200, positional information about the electric vehicle 200, and information indicating the charging state of the electric vehicle 200. On the basis of a vehicle request received by the communication unit 110 from the terminal device 300 of the user U, the vehicle notification information 164 stored in the storage unit 160, and master information about each shelter stored in advance in the storage unit 160, an optimum vehicle dispatch pattern for dispatching the electric vehicle 200 is calculated, and information instructing dispatch of the electric vehicle 200 according to the vehicle dispatch pattern is output.

Thus, it becomes possible to encourage a match in a database of the storage unit 160 of the vehicle dispatch service device 100 between a shelter and the electric vehicle 200. This allows selection of an appropriate number of electric vehicles 200 and dispatch of these electric vehicles 200 to respective shelters having different capacities for persons to be accommodated and thus differing in required electricity or fuel from each other, thereby allowing uniform and optimum vehicle dispatch to each shelter. As the vehicle dispatch pattern is calculated on the basis of positional information about the electric vehicle 200 and positional information about the shelter, a shortest route to the shelter can be defined to reduce wasteful use of electricity from the electric vehicle 200.

The electric vehicle 200 includes the external monitoring unit 280 as a situation acquisition device configured to acquire situation information about a traveling area where the electric vehicle 200 is traveling, the vehicle notification information 164 includes the situation information, and the acceptance unit 120 stores the situation information as the vehicle notification information 164 into the storage unit 160. By doing so, if there is submergence due to flooding, stone fall, fall of ground, or bridge collapse on a route to a shelter along which the electric vehicle 200 toward the shelter is to travel, or if positional information about an electric vehicle having started previously toward the shelter stops changing at a position before arrival at the shelter (if this previous electric vehicle is hit by an accident and becomes disabled to move), for example, the possibility or impossibility of dispatch of the electric vehicle 200 intended to be directed to the shelter can be determined using the situation of a road toward the shelter. For example, it is determined that dispatch of this electric vehicle 200 to the shelter should be avoided.

The electric vehicle 200 is a vehicle capable of driving by self-driving, and the management unit 140 instructs the electric vehicle 200 to move to the shelter by self-driving. By doing so, even if the electric vehicle 200 is hit by an accident such as stone fall or fall of ground on the way to the shelter, for example, it still becomes possible to avoid loss of human life.

The master information includes information about a minimum quantity of electricity usage at each shelter. This allows calculation of the number of required electric vehicles that may be the number of electric vehicles and a degree of charging of each of these electric vehicles, for example.

The master information includes information about the presence or absence of a power generating facility at the shelter, and information about a minimum quantity of fuel required for generating a minimum quantity of electricity usage at the shelter. By doing so, when the electric vehicle is to be dispatched to the shelter with the power generating facility, the electric vehicle to be dispatched is allowed to travel toward the shelter while being loaded with fuel of a required quantity. Additionally, a person handling the fuel can be carried to the shelter.

The electric vehicle is a hybrid vehicle with an internal combustion engine and a motor to generate power using the drive power of the internal combustion engine, or a fuel cell vehicle. In this case, if there is a need of boiling water at the shelter, heat generated by the power generation by the hybrid vehicle can be used for the boiling.

The present invention is not limited to the embodiment described above but the present invention also includes modifications, improvements, etc. within a range in which the purpose of the present invention is attainable. For example, the configurations of units including a communication unit, an acceptance unit, a calculation unit, and a management unit are not limited to the configurations of the units of the embodiment including the communication unit 110, the acceptance unit 120, the calculation unit 130, and the management unit 140. For example, the electric vehicle may not be a self-driving vehicle. The fuel cell vehicle may include a battery further available for traveling.

In the embodiment, regarding the type of an electric vehicle to be selected, any electric vehicle to be caused to travel by an electric motor to be driven by electric power supplied from a secondary cell (battery) is selectable. Examples of the selectable electric vehicle include a battery electric vehicle (BEV), a hybrid electric vehicle (HEV), a plug-in hybrid electric vehicle (PHEV), a fuel cell vehicle (FCV), and a plug-in fuel cell vehicle (PFCV). If the type of the electric vehicle to be selected is a hybrid vehicle such as a hybrid electric vehicle (HEV), a plug-in hybrid electric vehicle (PHEV), a fuel cell vehicle (FCV), or a plug-in fuel cell vehicle (PFCV), the calculation unit may calculate a vehicle dispatch pattern for causing a fuel supply vehicle capable of supplying fuel to the electric vehicle to arrive at the shelter to coincide with timing of running out of fuel in the electric vehicle required for power generation. This makes it possible to avoid a trouble such as failing to supply electricity to the shelter due to running out of fuel in the electric vehicle.

If the type of the electric vehicle to be selected is a battery electric vehicle (BEV), the calculation unit may be configured to calculate a traveling permitting residual charged quantity indicating a residual charged quantity in the electric vehicle allowing the electric vehicle to travel from the shelter to a charging station ready for charging. By doing so, if there are no sufficient number of electric vehicles capable of being dispatched to the shelter, if supply of electricity to the shelter using electric vehicles is to be prolonged, and if a vehicle dispatched to the shelter for supply of electricity to the shelter is a battery electric vehicle (BEV), the dispatched vehicle can be charged at the charging station ready for charging, and then can be used again for supply of electricity at the shelter.

If the type of the electric vehicle to be selected is a fuel cell vehicle, the calculation unit may be configured to calculate a traveling permitting residual charged quantity indicating a residual charged quantity in the electric vehicle allowing the electric vehicle to travel from the shelter to a hydrogen station ready for charging. In the case of a fuel cell vehicle, the traveling permitting residual charged quantity may be calculated by giving consideration not only to a residual charged quantity in a battery further available for traveling but also to a hydrogen quantity remaining in a hydrogen tank. By doing so, if there are no sufficient number of electric vehicles capable of being dispatched to the shelter, if supply of electricity to the shelter using electric vehicles is to be prolonged, and if a vehicle dispatched to the shelter for supply of electricity to the shelter is a fuel cell vehicle, the dispatched vehicle can be charged with hydrogen at the hydrogen station, and then can be used again for supply of electricity at the shelter.

If the type of the electric vehicle to be selected is a hybrid vehicle (HEV or PHEV), the calculation unit is preferably configured to calculate a traveling permitting residual charged quantity indicating a residual charged quantity in the electric vehicle allowing the electric vehicle to travel from the shelter to a gas station ready for charging. The traveling permitting residual charged quantity may be calculated by giving consideration not only to a residual charged quantity in a battery further available for traveling but also to residual fuel remaining in a fuel tank. By doing so, if there are no sufficient number of electric vehicles capable of being dispatched to the shelter, if supply of electricity to the shelter using electric vehicles is to be prolonged, and if a vehicle dispatched to the shelter for supply of electricity to the shelter is a hybrid vehicle, the dispatched vehicle can be charged with fuel at the gas station, and then can be used again for supply of electricity at the shelter.

The calculation unit may calculate a vehicle dispatch pattern on the basis of the traveling permitting residual charged quantity for causing one electric vehicle to arrive at the shelter to coincide with timing of reach of the traveling permitting residual charged quantity by a residual charged quantity in a different electric vehicle. This makes it possible to avoid the occurrence of shortage of electric vehicles to supply electricity at the predetermined shelter.

### EXPLANATION OF REFERENCE NUMERALS

1 . . . vehicle system
100 . . . vehicle dispatch service device
110 . . . communication unit
120 . . . acceptance unit
130 . . . calculation unit
140 . . . management unit
150 . . . derivation unit
160 . . . storage unit
161 . . . vehicle information
162 . . . user information
164 . . . vehicle notification information
200-1 to 200-n, 200 . . . electric vehicle

What is claimed is:

1. A vehicle dispatch service device for dispatch to a shelter, the device comprising:
a communication unit that makes communication with a vehicle-installed communication device and with a terminal device of a user;
a calculation unit that calculates an optimum vehicle dispatch pattern for dispatching an electric vehicle on the basis of a vehicle request received by the communication unit from the terminal device of the user, vehicle notification information stored in a storage unit, received by the communication unit, and including identification information about the electric vehicle, positional information about the electric vehicle, and information indicating a charging state of the electric vehicle, and master information about each shelter stored in advance in the storage unit; and
a management unit that outputs information instructing dispatch of the electric vehicle according to the vehicle dispatch pattern calculated by the calculation unit.

2. The vehicle dispatch service device for dispatch to a shelter according to claim 1, wherein
the electric vehicle includes a situation acquisition device configured to acquire situation information about a traveling area where the electric vehicle is traveling,
the vehicle notification information includes the situation information, and
the vehicle notification information stored in the storage unit includes the situation information.

3. The vehicle dispatch service device for dispatch to a shelter according to claim 1, wherein
the electric vehicle is a vehicle capable of driving by self-driving, and
the management unit instructs the electric vehicle to move to the shelter, by self-driving.

4. The vehicle dispatch service device for dispatch to a shelter according to claim 1, wherein
the master information includes information about a minimum quantity of electricity usage at each shelter.

5. The vehicle dispatch service device for dispatch to a shelter according to claim 1, wherein
the master information includes information about the presence or absence of a power generating facility at the shelter, and information about a minimum quantity of fuel required for generating a minimum quantity of electricity usage at the shelter.

6. The vehicle dispatch service device for dispatch to a shelter according to claim 1, wherein
the electric vehicle is a hybrid vehicle including an internal combustion engine and a motor to generate power using the drive power of the internal combustion engine/ or a fuel cell vehicle.

7. The vehicle dispatch service device for dispatch to a shelter according to claim 6, wherein the calculation unit calculates the vehicle dispatch pattern for causing a fuel supply vehicle capable of supplying fuel to the electric vehicle to arrive at the shelter to coincide with timing of running out of fuel in the electric vehicle required for power generation.

8. The vehicle dispatch service device for dispatch to a shelter according to claim 1, wherein
the electric vehicle is a battery electric vehicle, and
the calculation unit is configured to calculate a traveling permitting residual charged quantity indicating a residual charged quantity in the electric vehicle allowing the electric vehicle to travel from the shelter to a charging station ready for charging.

9. The vehicle dispatch service device for dispatch to a shelter according to claim 8, wherein the vehicle dispatch pattern is calculated for causing one electric vehicle to arrive at the shelter to coincide with timing of reach of the traveling permitting residual charged quantity by a residual charged quantity in a different electric vehicle.

10. A vehicle dispatch service method for dispatch to a shelter, the method being implemented by a vehicle dispatch service device for dispatch to the shelter comprising a communication unit that makes communication with a vehicle-installed communication device and with a terminal device of a user, the method comprising:
calculating an optimum vehicle dispatch pattern for dispatching an electric vehicle on the basis of a vehicle request received by the communication unit from the terminal device of the user, vehicle notification information stored in a storage unit, received by the communication unit, and including identification information about the electric vehicle, positional information about the electric vehicle, and information indicating a charging state of the electric vehicle, and master information about each shelter stored in advance in the storage unit; and outputting information instructing dispatch of the electric vehicle according to the vehicle dispatch pattern.

11. A non-transitory computer-readable medium storing a program for causing a vehicle dispatch service device for dispatch to a shelter to perform a process, the vehicle dispatch service device comprising a communication unit that makes communication with a vehicle-installed communication device and with a terminal device of a user, the process comprising:
calculating an optimum vehicle dispatch pattern for dispatching an electric vehicle on the basis of a vehicle request received by the communication unit from the terminal device of the user, vehicle notification information stored in a storage unit, received by the communication unit, and including identification information about the electric vehicle, positional information about the electric vehicle, and information indicating a charging state of the electric vehicle, and master information about each shelter stored in advance in the storage unit; and outputting information instructing dispatch of the electric vehicle according to the vehicle dispatch pattern.
